(19) United States
(12) Patent Application Publication
(10) Pub. No.: US 2026/0319864 A1
(43) Pub. Date: Oct. 15, 2026

(54) SYSTEMS AND METHODS FOR EFFICIENTLY PROCESSING AND MANAGING EVENT DATA

(71) Applicant: Target Brands, Inc., Minneapolis, MN (US)

(72) Inventor: John David Tinetti, Arvada, CO (US)

(21) Appl. No.: 19/175,851

(22) Filed: Apr. 10, 2025

(51) Int. Cl. G06F 9/54; G06Q 10/087

(52) U.S. Cl. CPC G06F 9/542; G06Q 10/087

(57) ABSTRACT

Systems and methods for processing inventory item updates can include receiving one or more event messages for one or more inventory item updates for one or more event families. One or more update identifiers for the event messages can be stored in a queue. The update identifiers include a first update identifier for a first event message for a first event family. The update identifiers included in the queue for each of the event families can be counted. The first update identifier can be received from the queue. It can be determined if the first update identifier is the last update identifier from the queue for the first event family based on a first counter. Based on the determining if the first update identifier is the last update identifier from the queue, the first event message can be processed or not processed.

### TECHNICAL FIELD

This specification generally relates to technology for efficiently processing and managing event data, such as event updates from streams of events data.

### BACKGROUND

Complex systems, such as supply chains, have been designed to generate event data related to various activities, milestones, or other occurrences related to items that are being processed, tracked, or otherwise managed within the systems. For example, supply chain systems can include multiple different actors, such as carriers, that are transporting goods between locations, such as between the supplier location and a distribution center for the goods. Events can be generated at various points along the transportation of these goods, such as when a carrier arrives at one location, begins loading the goods, completes loading the goods, begins traveling to the destination location, reaches various waypoints along the pathway to the destination, arrives at the destination, begins unloading the goods, completes unloading the goods at the destination, and other events. These events can be generated for groups of goods, such as truckloads, pallets, cases, or other groupings of goods, or can be generated on an individual item basis. Within complex systems, aggregate event data can be on the order of millions to billions (or more) of events per day.

Event data can be organized and provided in various event streams, such as through published topics, like KAFKA topics. Various systems can be designed to process, access, and use the event data to track, manage, and make decisions related to the event data. For example, in the supply chain context, supply chain management computer systems can be configured to access supply chain event data to determine whether goods are on track, behind schedule, or ahead of schedule in their delivery to their destination location, which can aid in determining and performing various supply chain operations. For example, supply chain operations can include prioritizing goods that are behind schedule for unloading relative to other goods that are on or ahead of schedule when arriving at a distribution center.

Supply chains are, in general, complex networks through which goods are supplied from producers to retailers and, ultimately, consumers. Numerous goods in a supply chain may be tracked as they move through the supply chain. As a result, large amounts of data and processing resources can be used in tracking goods through a supply chain which can cause inefficiencies and use excess resources.

### SUMMARY

This document generally describes computer systems and processes for efficiently processing and managing events data within a complex system, such as for efficiently processing and managing inventory event data and corresponding updates in a supply chain. Complex systems, like supply chains, that generate voluminous event data can present challenging computational problems in terms of processing speed, computational resource usage, and contextually informed decisions. For example, a system that is designed to quickly process event data may require significant computational resources (e.g., CPU cycles, RAM, network bandwidth), whereas a system that is designed to use fewer computational resources may have slower computational speeds. In another example, systems can be configured to process and evaluate data on individual events in isolation or with minimal associated context, which can use fewer computational resources and can be more quickly performed, but it can come at the expense of performing operations that generate results that are less contextually accurate by ignoring other relevant event data. The disclosed technology is generally directed to efficiently processing and managing event messages in complex system, such as event data for inventory items tracked through a supply chain, by processing events that are determined not to be intermediate updates. For example, the described technologies can allow events that are determined to be relevant to the current state of inventory to be processed and persisted in memory for use in processing as associated inventory items are tracked through a supply chain. The disclosed technology can permit for a reduced set of relevant event messages to be processed and persisted in memory – providing for more efficient processing using fewer computational resources, greater computational speed, and more contextually accurate event modeling and processing.

In some implementations, a method for processing inventory item updates can include receiving one or more event messages for one or more inventory item updates for one or more event families. The method further includes storing one or more update identifiers for the one or more event messages in a queue, wherein the one or more update identifiers comprise a first update identifier for a first event message for a first event family. The method further includes counting how many of the one or more update identifiers are included in the queue for each of the one or more event families. The method further includes receiving the first update identifier from the queue. The method further includes determining if the first update identifier for the first event message is the last update identifier from the queue for the first event family based on a first counter for the first event family. The method further includes processing the first event message or not processing the first event message based on the determining if the first update identifier is the last update identifier from the queue for the first event family.

Other implementations of this aspect include corresponding computer systems and include corresponding apparatus and computer programs recorded on one or more computer storage devices (e.g., computer-readable memory, etc.), each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

These and other implementations can include any, all, or none of the following features. For example, a second update identifier for a second event message from the queue can be received. A determination can be made that the second update identifier is not the last update identifier from the queue for a second event family based on a second counter for the second event family. A state of a first inventory item associated with the first event family can be stored in database. The storing of the state of the first inventory item can include storing the first event message in the database based on the first evet family. For example, the counting of how many of the one or more update identifiers are included in the queue for each of the one or more event families comprises incrementing one or more counters associated with the one or more event families based on the received one or more event messages. The determining if the first update identifier is the last update identifier from the queue for the first event family comprises decrementing a first counter for the first event family. The first counter can count an amount of the one or more update identifiers that are included in the queue for the first event family. The first update identifier can be removed from the queue based on the receiving the first update identifier from the queue. The one or more update identifiers can be stored in the queue based on an order the one or more event messages are received from one or more event logs. The first event message can be processed if the first update identifier is determined to be the last update identifier from the queue for the first event family based on the first counter for the first event family. The processing can include generating a transfer plan. The event logs can include one or more topics. The one or more event messages for the one or more event families can be received at one or more consumer applications that subscribe to the one or more topics.

The systems, devices, program products, and processes described throughout this document can, in some instances, provide one or more of the following advantages. In some implementations, computational efficiencies can be made by limiting the computationally expensive processing to event messages for updates that are current and not intermediate updates.

Other features, aspects and potential advantages will be apparent from the accompanying description and figures.

### DESCRIPTION OF DRAWINGS

FIG. 1 depicts an example system for processing update event messages for inventory items in a supply chain.

FIG. 2 is a diagram that shows an example supply chain in which processing of updates for inventory items can be used.

FIG. 3 is a flowchart of an example process for processing an event update for an inventory item in a supply chain.

FIG. 4 is a diagram that shows an example application ingesting event messages for evaluating updates for inventory items in a supply chain.

FIG. 5 is a diagram that shows an example application that can evaluate one or more update identifiers for processing updates for inventory items in a supply chain.

FIG. 6 is a flowchart of an example process for processing an event update for an inventory item.

FIG. 7 is a diagram showing an example architecture in which processing of updates to inventory items can be used.

FIG. 8 is a schematic diagram that shows an example of a computing system.

Like reference symbols in the various drawings indicate like elements.

### DETAILED DESCRIPTION

This document describes technology that can efficiently process event messages for updates to inventory items tracked through a supply chain. As the number of items that are tracked through a supply chain increases, the computational processing and data resources used can increase. In some implementations, when processing changes and/or updates for inventory items in a supply chain at scale, computational expense can be reduced by processing a subset of relevant updates generated in a supply chain system. For example, when an attribute and/or data field included in an event message used to track an inventory item is updated and/or changed, if the change to the information record for the inventory item is old or outdated it may not be applicable to one or more other downstream processing applications and/or services and can be ignored for further processing from those applications and/or services. To avoid inefficient processing of intermediate updates, intermediate updates can be avoided until a determination is made that the most current update or updates for an inventory item are received and/or persisted and then the persisted current update (e.g., current event message update for the inventory item) or updates can be processed. Allowing processing of event messages for relevant and/or recent updates, for example, can be beneficial as not all updates in a distributed event streaming environment can be used by specific applications or services, and processing relevant event message updates can generate processing efficiencies while capturing updates in inventory tracking that maintain a relevant state of the supply chain.

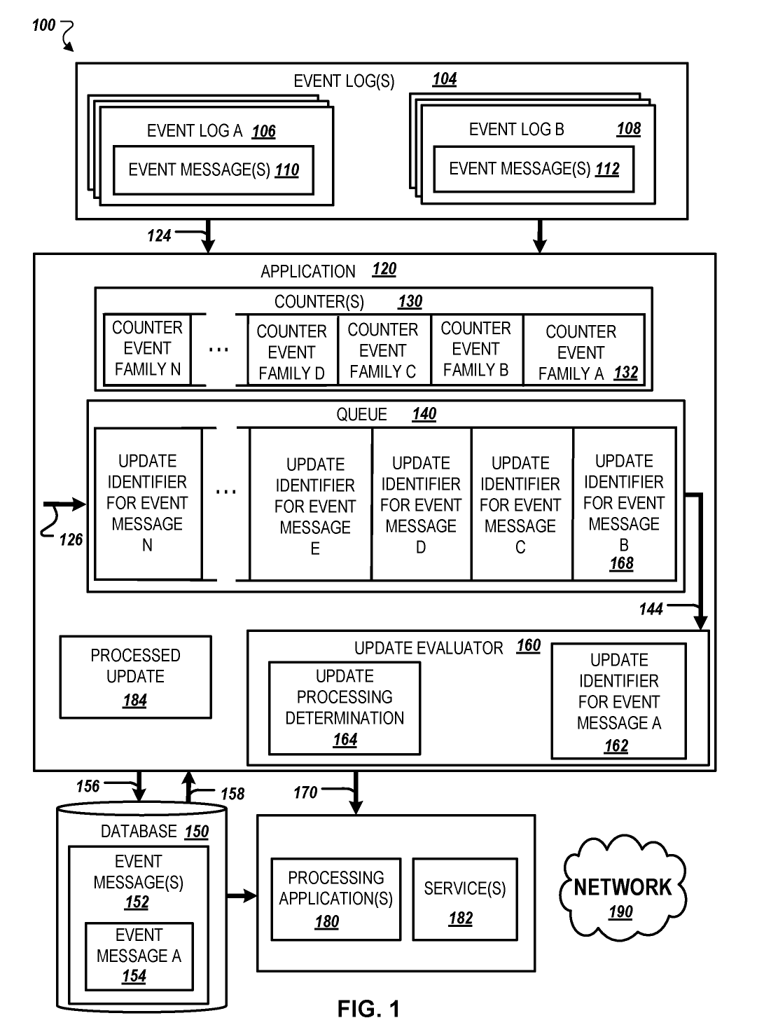

FIG. 1 depicts an example system 100 for processing one or more event messages for updates for one or more inventory items in a supply chain. In the example of FIG. 1, the system 100 includes one or more event logs 104 including event logs 106 and 108. In some implementations, an event log (e.g., topic, KAFKA topic, etc.), for example, can store and/or organize one or more event messages associated with a state of a supply chain. For example, the event log can store and/or organize one or more event messages including event messages associated with an inventory item in a supply chain. In one implementation, event logs can communicate event information to consumer applications that subscribe to receive information from the event logs. In some implementations, an event log can be partitioned over one or more brokers (e.g., KAFKA brokers, etc.). In an example implementation, event logs can provide one or more event messages as part of one or more event streams. In FIG. 1, the network 190 can be used to communicate information between one or more components of system 100 including but not limited to the one or more event logs 104, one or more applications such as the application 120, the database 150, and/or other components of system 100.

The system 100 includes one or more event messages including event messages 110 and 112. In FIG. 1, the event messages 110 can include updated information in a set of one or more attributes that provide information related to the inventory item. For example, an attribute can include but is not limited to item identification information (e.g., inventory item identifier, etc.), item location information (e.g., location identifier, etc.), quantity, or other attribute. The event log can include other event messages with prior updates and/or events for the inventory item. For example, an event log can include one or more event messages that reflect updates to the state of an inventory item as it moves through a supply chain over time. In some implementations, event messages associated with an inventory item can be organized in the event log based on the time that the update event took place for the inventory item. For example, when an event and/or change to the inventory item happens in the supply chain, an event message can be created and included and/or organized in an event log based on the time it was created.

As shown at 124, one or more event messages for one or more inventory items are received by one or more applications (e.g., consumer applications, client applications, etc.) such as the application 120. In some implementations, the application 120, for example, can subscribe to receive information (e.g., event messages, communications, data, etc.) from the one or more event logs 104 using one or more event streams within an event streaming platform. In some implementation, the application 120 can receive information (e.g., event messages, data, communications, etc.) from the one or more event logs using connections including connections through the network 190. In some implementations, the one or more event messages can be ingested through ingestion processing as they are received by the application 120. In some implementations, for example, the ingestion of an event message at the application 120 can include generating an update identifier for the event message. In some implementations, as the one or more event messages are received by the application 120, one or more update identifiers can be generated for the one or more event messages. For example, an update identifier can be generated for each event message that is received. In some implementations, an update identifier generated for an event message can be associated with the event message based on an item identifier included in the event message. For example, key data included in the event message can include an item identifier that can be included in the update identifier to associate the update identifier with the event message and/or an event family for (e.g., associated with) the event message. In some implementations, an update identifier can be a smaller object than its associated event message such that the update identifier can include less data. In another implementation, the update identifier may not be a smaller object than its associated event message. In some implementations, the one or more update identifiers can be sent to a queue 140. In some implementations, as shown at 126, the one or more update identifiers can be sent to (e.g., stored on, put on, etc.) the queue 140 in the order the one or more event messages are received so the update identifiers are organized in the queue based on a time of receipt for the respective event messages at the application 120.

In some implementations, for example, the ingestion of an event message at the application 120 can include incrementing a counter for an event family for (e.g., associated with) the event message. In some implementations, the application 120 can increment one or more counters 130 in response to (e.g., based on) the one or more event messages being received at the application 120. For example, the application 120, upon ingestion of an event message, can increment a counter for an identified event family associated with the event message to count how many update identifiers are included in the queue for the identified event family. The incrementing can reflect the count of update identifiers for the identified event family included in the queue for when the update identifier associated with the received event message is added to the queue. In some example implementations, event messages can be grouped into (e.g., associated with, included in, etc.) an event family based on being associated with an inventory item. For example, event messages generated for updates to an inventory item within an inventory replenishment system can include an item identifier for the inventory item in their data and can be grouped in the event family based on the item identifier and association with the identified inventory item. In some implementations, an event family associated with an inventory item can be identified using an item identifier associated with the inventory item. In some implementations, the event messages, for example, for updates to an inventory item can be included in an event family for the inventory item.

In some implementations, for example, the ingestion of an event message at the application 120 can include storing the event message in the database 150. With reference to FIG. 1, in response to receiving the one or more event messages, the application 120 can store at least some of the one or more event messages 152 in a database 150. For example, when an event message 154 is received by the application, the application can store, as shown at 156, the event message 154 in the database 150 to persist the state of the inventory item associated with the event message 154. In some implementations, an event message can be stored in the database 150 as the most current update of the state of the inventory item identified by the item identifier included in the event message. In some implementations, an event message can be stored in the database 150 as a current update of the state of the inventory item based on one or more attributes. For example, if there is an update to the location of an inventory item within a supply chain, the event message including the update can be stored in the database 150 based on key data including but not limited to an item identifier and location information (e.g., a location ID, location number, etc.).

The application 120 can include an update evaluator 160. The update evaluator 160 can receive, as shown at 144, one or more update identifiers such as update identifier 162 from the queue 140. In the example implementation of FIG. 1, the update evaluator 160 can determine if a received update identifier is the last update identifier from the queue for its event family. For example, the update identifier 162 can be evaluated by the update evaluator 160 to determine if the update identifier 162 is the last update identifier from the queue 140 for its event family. Upon receiving the update identifier 162, the update evaluator 160 can decrement the counter 132 for the event family associated with the update identifier 162 and its corresponding event message. Once the counter is decremented, the counter can be evaluated by the logic of the update evaluator 160 to determine if the event message 162 is the last member of its event family from the queue. For example, if the value for counter 132 indicates there are no other event messages in the queue for the event family of event message 162 then the update evaluator can determine and/or return that event message 162 is the last member of its event family from the queue. In other implementations, if the value for counter 132 indicates there are other event messages in the queue for the event family of event message 162 then the update evaluator can determine and/or return that event message 162 is not the last member of its event family from the queue.

In the example implementation of FIG. 1., the update evaluator 160 can make an update processing determination 164 to allow the event message 154 to be further processed or not to be further processed based on the evaluation of if the update identifier 162 is the last member of its event family from the queue 140. In some implementations, if the update identifier 162 is the last member of its event family that is from the queue 140, then the associated event message 154 can be processed using application 120. In some implementations, the event message 154 can be retrieved from the database 150 for processing as shown at 158. For example, the event message 154 can be the most current update for its associated inventory item that is persisted in the database 150 that can be retrieved for processing (e.g., expensive processing). In some implementations, the processing of event message 154 can generate one or more processed updates such as processed update 184. In some implementations, based on the determination that the update identifier 162 is the last member of its event family from the queue 140, one or more event messages stored in the database 150 that are associated with the event family of the update identifier 162 can be processed. For example, if there are event messages stored in the database 150 that are associated with an inventory item for the event family of the update identifier 162, the event messages associated with event family and/or the inventory item can also be processed. Processing the stored event messages associated with updates for an inventory item can be efficient when it is determined that the most current updates are persisted in the database 150 and the intermediate updates have been filtered out. Also, for example, if the update identifier 162 is the last member of its event family from the queue 140, then one or more event messages associated with the event family of the event message 154 that are stored in the database 150 can be provided downstream for processing by one or more processing applications 180 and/or one or more services 182 as shown at 170. In one implementation, if an update identifier is the last member of its event family from the queue 140, its associated event message can be relevant to downstream processing as the most current update available for the associated inventory item and the associated event message can be processed. For example, the event message can be provided to the application 120 and/or one or more processing applications 180 to be processed. In another implementation, if an update identifier such as update identifier 168 is determined not to be the last member of its event family from the queue 140, then the event message from which the update identifier 168 was generated can be identified as an intermediate update and/or older update including outdated information and one or more processes (e.g., expensive processes) can be ignored and/or skipped for the associated intermediate update event message.

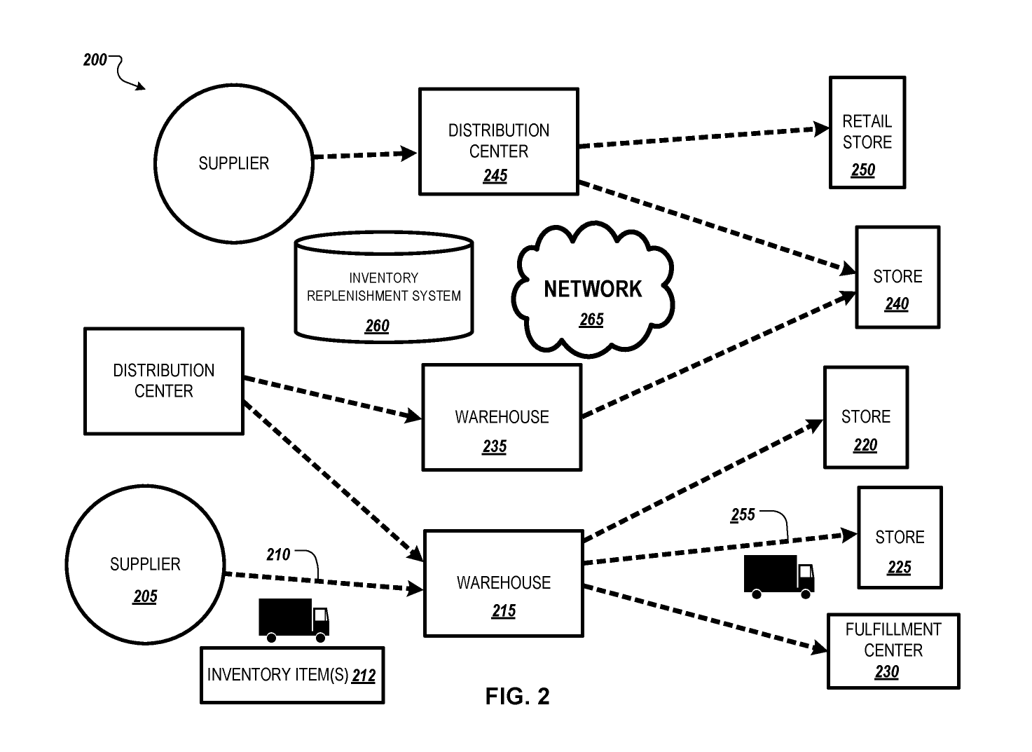

FIG. 2 is a diagram that shows an example supply chain 200 in which processing updates for inventory items can be used. The supply chain 200 includes a network of facilities where inventory can be received and/or sent to move or position retail inventory or merchandise within the supply chain. In the example shown in FIG. 2, one or more suppliers such as supplier 205 can send one or more shipments such as inventory shipment 210 to one or more warehouses such as warehouse 215. For example, a supplier can supply one or more inventory items 212 to a warehouse before the one or more inventory items are delivered to a retailer. The warehouse 215 can receive the inventory shipment 210 as an inbound shipment from the supplier 205. In some implementations a warehouse can be associated with one or more retail locations such that the warehouse supplies the retail locations with inventory through shipments. For example, warehouse 215 can be associated with supply retail stores 220 and 225 as well as fulfillment center 230. Also, for example, warehouse 235 can supply retail store 240 and distribution center 245 can supply retail store 240 and retail store 250. In some examples, a warehouse can include a distribution center, a flow center, or the like. In the example of FIG. 2, one or more warehouses such as warehouse 215 can ship inventory 255 to one or more retail stores such as retail store 225 to position inventory in the supply chain 200.

In an example implementation, an inventory replenishment system 260 can track where inventory is located in the supply chain network and can determine where inventory can be moved to within the network of the supply chain 200. In some implementations an inventory replenishment system 260 can be implemented to include an architecture that includes a distributed event store and/or stream-processing platform (e.g. APACHE KAFKA, etc.) distributed over one or more networks such as network 265. In some implementations, the inventory replenishment system 260 can use event streaming to store and process events (e.g., event messages, event records, records, messages, etc.) generated by changes in the supply chain 200, including updates to one or more inventory items, to update and maintain the state of the supply chain 200. The inventory replenishment system 260 can track inventory supply movements for various facilities and retailers and can determine where inventory can be moved from to be relocated at designated retailers to replenish retailer inventories. As inventory items move through the supply chain 200 the state of inventory maintained by the inventory replenishment system 260 can be updated to reflect an updated state of inventory and/or inventory items. For example, after the inventory shipment 210 arrives at warehouse 215 from supplier 205, the inventory shipment 210 can be evaluated to determine what is in the shipment and the inventory state stored by the inventory replenishment system 260 can be updated to reflect information about the received inventory items. For example, the inventory state can be updated with information indicating where an inventory item is located, a quantity of the item, or other attribute information associated with the received inventory items in the shipment. In some implementations, the inventory state can be updated with information regarding one or more item attributes and/or location attributes for one or more inventory items. For example, an item attribute can include but is not limited to information about if the inventory item is flammable or not flammable, information about how the inventory item can be allocated and/or moved based on the facility (e.g., warehouse, store, etc.) where it is stored, information about one or more policies associated with the item (e.g., a replenishment hold policy with instructions not to allocate the inventory item to one or more specified locations, or other policy), or other item attribute. The inventory replenishment system, for example, can store information associated with each item in a shipment (e.g., location identifier, item identifier, shipment identifier, purchase order identifier, etc.). For example, as the state of the supply chain changes, a latest state can be determined by updating the system with one or more recent changes to determine a latest state. In some implementations, changes and/or updates to one or more inventory items in the supply chain can be stored and/or recorded as one or more event messages for the one or more inventory items. In some implementations, intermediate updates can be used to update the state before a latest and/or most current state is determined. The supply chain state, for example, can include locations, movements, and amounts of items in a supply chain. In some implementations, over time the state of the supply chain can change as inventory can enter the supply chain, move through the supply chain, be altered in the supply chain and/or can exit the supply chain. Tracking inventory, for example, through the supply chain and determining where inventory can be relocated can become more computationally complex and requires more resources as the number of items increases and the number of retailers supplied increases.

Processing the state of the supply chain at a large scale, for example, can be computationally complex and maintaining an accurate state of a supply chain that can change rapidly can be difficult. Updating the state of inventory (e.g., an inventory item, etc.), for example, before making decisions can create efficiencies as having a more accurate and updated state of inventory can allow for inventory movement decisions to be made more accurately and with less complexity by the inventory replenishment system 260. In some implementations, in a supply chain, processing current updates to the state of inventory items and not processing intermediate updates can create efficiencies in computation in a high throughput data environment produced by tracking inventory items through the state of a supply chain by limiting the number of updates that are processed by an inventory replenishment system.

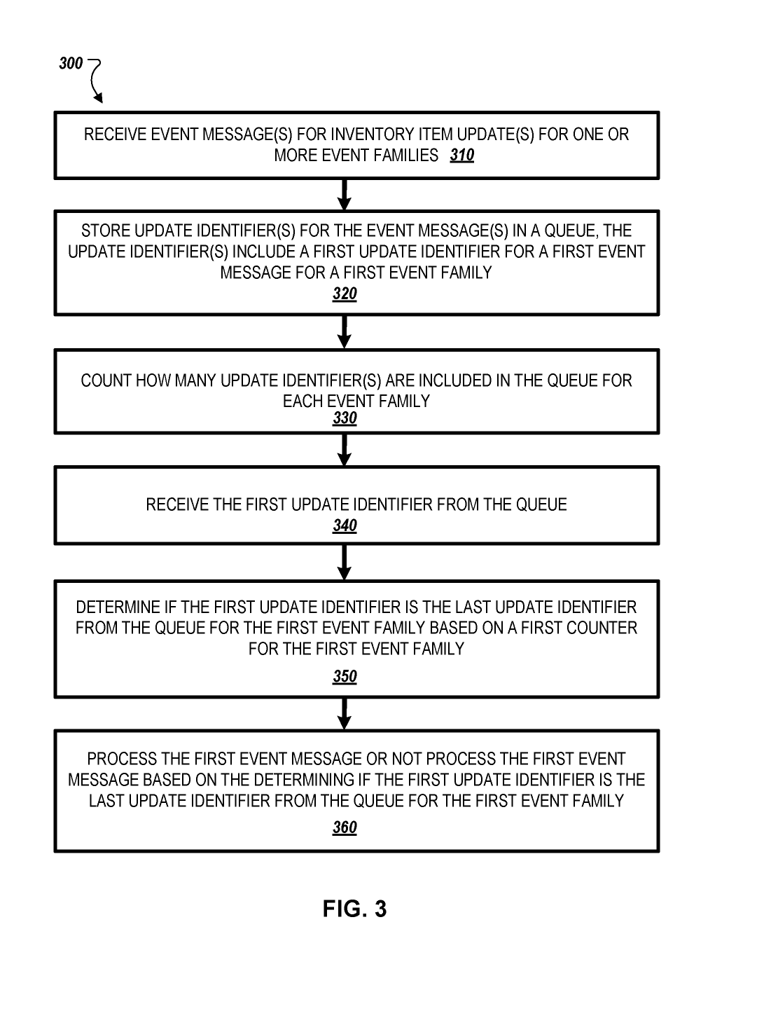

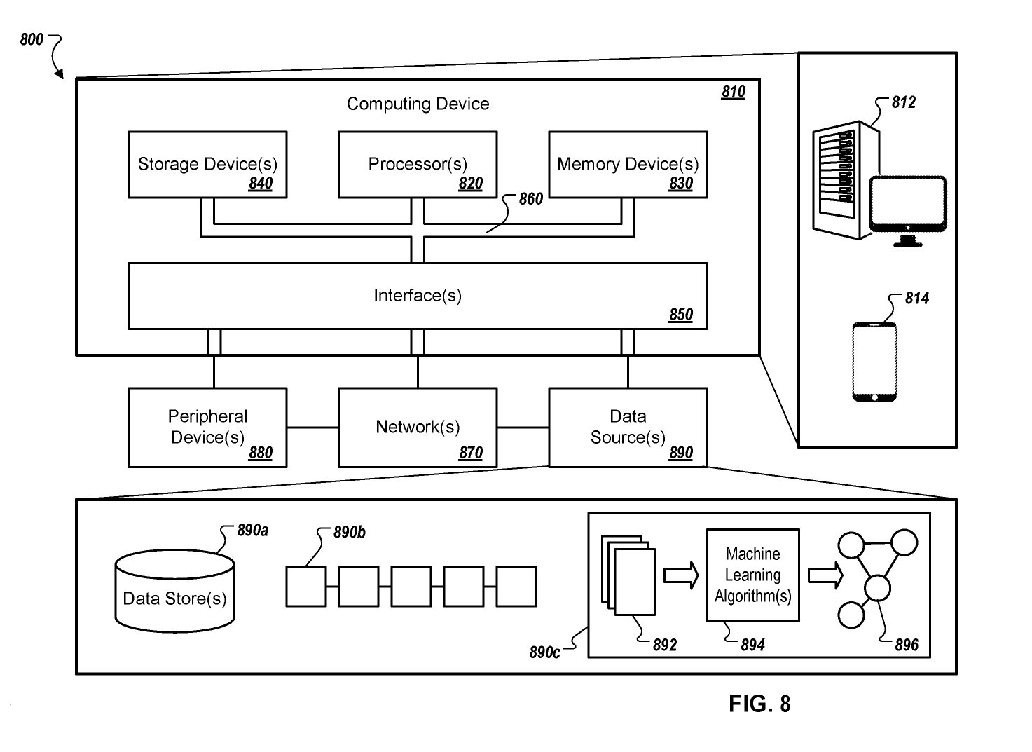

FIG. 3 shows a diagram of an example process 300 for processing an update for an inventory item in a supply chain. The process 300 can be performed using one or more computing systems, as described and depicted herein. For example, the process 300 can be performed by the computing system 800 in FIG. 8. In the example implementation of FIG. 3, at step 310, one or more event messages for one or more inventory item updates for one or more event families can be received. The one or more event messages can include a first event message for a first event family associated with a first inventory item. For example, an application (e.g. subscriber application, consumer application, client application, etc.) can receive one or more event messages from one or more event logs (e.g., topics, event streams, etc.). The one or more event messages can be grouped based on one or more event families. In an example implementation, an event message can be included in an event family based on an item identifier (e.g., product identifier, stock keeping unit (SKU), TCIN, product number, etc.). For example, an event message can be associated with (e.g., a member of, included in, etc.) the event family that is grouped based on the information included in the event message that indicates an item identifier. In some implementations, an event family, for example, can be based on an item identifier for an inventory item (e.g., a product), or other identifier associated with the inventory item. For example, one or more updates and/or changes (e.g., events) for an inventory item can happen over time producing one or more event messages, and the associated one or more event messages can be included in an event family for the inventory item based on the inventory item’s product identifier or other identifier associated with the inventory item. In one example implementation, the item identifier for the inventory item can be included in at least one message field of the event message. In some implementations, the state of an inventory item can be updated (e.g., in an inventory replenishment system, in an application, etc.) based on (e.g., using, by processing, etc.) event messages that indicate changes or updates to the inventory item as it is tracked through the supply chain. In some implementations, inventory item updates can be updates (e.g., event messages, event message updates, events, etc.) indicating a change to the state of an inventory item within a supply chain. For example, as an inventory item moves through a supply chain the state for the inventory item can change as the location of the inventory item changes and its changes in location can be indicated as event messages to update the state (e.g., location, etc.) information of the inventory item within systems and processes of the supply chain.

At 320, one or more update identifiers can be stored in a queue. The one or more update identifiers can include a first update identifier for a first event message for a first event family. For example, as one or more event messages are received at the application, for each of the received event messages, a respective update identifier can be generated that is associated with the respective event message and the event family associated with the event message, and each of the generated update identifiers can be sent to be stored on a queue. In some implementations, each generated update identifier can be sent to be stored on the queue in the order that is based on the order their associated event messages were received at the application. For example, when an event message is received its respective update identifier can be generated and sent to the queue before the update identifier generated for the next received event message is stored on the queue. In one implementation, the queue, for example, can be a KOTLIN channel. In other implementations, the queue can be a different queue.

At 330, the amount of the one or more update identifiers that are included in the queue for each of the one or more event families can be counted. For example, when an event message is received at the application, a counter for the event family associated with the event message can be incremented. By incrementing the counter when an event message is received at the application, the counter for the event family can count how many update identifiers for the specified event family are stored in the queue, because each received event message for the event family can have a respective associated update identifier stored in the queue.

At 340, the first update identifier can be received from the queue. For example, the first update identifier for the first event family can be the update identifier at the end of the queue and received by update evaluation logic (e.g., an update evaluator) to be evaluated. In response to the first update identifier being received by evaluation logic, the first update identifier can be removed from the queue. In one example implementation, when the first update identifier is received and removed from the queue, the update evaluation logic can decrement the counter for the event family associated with the received first update identifier.

At 350, it can be determined if the first update identifier is the last update identifier from the queue for the first event family based on a first counter for the first event family. For example, the first counter for the first event family can be evaluated (e.g., by update evaluation logic) to determine if the first update identifier is the last member of the first event family from the queue. The first counter can indicate the amount of update identifiers that are included in the queue for the first event family and if there are no other update identifier members in the queue for the first event family, then the first update identifier can be determined to be the last update identifier from the queue for the first event family.

At 360, the first event message can be processed or not processed based on the determining if the first update identifier is the last update identifier from the queue for the first event family. In one implementation, if it is determined that the first update identifier is the last update identifier from the queue for the first event family, the first event message can be processed. For example, the first event message can be received from a database and processed at an application as an update to the state of the associated inventory item in the supply chain that is relevant to downstream processing and/or services. In an example implementation, the first event message can be received along with one or more other event messages for the first event family from a database to be processed at an application. In some implementations, processing the first event message includes using the first event message in generating a transfer plan for the inventory item and/or using the first event message in further downstream processing and/or services including use with an inventory replenishment system. In another implementation, processing the first event message includes using the first event message in further computationally expensive processing that can include downstream processing. Computational efficiencies can be made by limiting the computationally expensive processing to event messages for updates that are current and not intermediate updates. For example, updating systems and/or a state of an inventory item based on the most current information for the inventory item can generate efficiencies when an intermediate state of the inventory item is not relevant to downstream processing. Also, for example, often in tracking an item through a supply chain, the most updated state of the item can be relevant to future processing and prior intermediate updates may not be relevant as the state of the item has changed from the intermediate state. In another implementation, if it is determined that the first update identifier is not the last update identifier from the queue for the first event family, the first event message is not processed. For example, if the first update identifier is not the last member of its event family from the queue, then the first update identifier can be determined to be associated with an intermediate update for the first event family and can be flagged as an intermediate update and/or one or more processes (e.g., expensive processes, etc.) can be skipped and/or ignored for the intermediate update. The one or more processes can be ignored and/or skipped because a more recent update event message for the first event family was identified as being included in the queue based on the first update identifier being determined to be associated with an intermediate update.

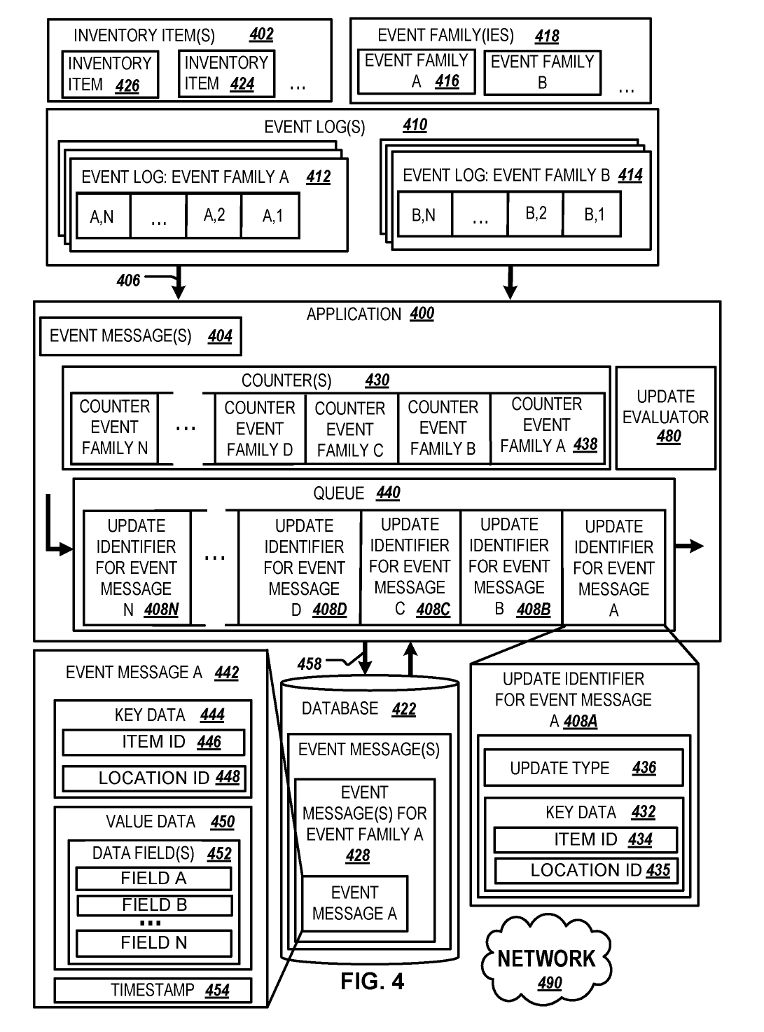

FIG. 4 is a diagram that shows an example application 400 ingesting one or more event messages 404 for processing one or more updates for one or more inventory items 402 in a supply chain. The functionality of application 400 can be included in one or more applications described and depicted herein such as applications in system 100 of FIG. 1. In some implementations, the application 400 can include a transfer plan generator which can be used to provide information about transfer plans for inventory items within a supply chain. In other implementations, the application can include other processing applications that process event messages for inventory items.

In the example of FIG. 4, the application 400 receives one or more event messages 404 through one or more event streams 406 for one or more event logs 410 including event logs 412 and 414. Event log 412 includes one or more event messages for a designated inventory item 426 that are members of the event family 416 for the inventory item 426. Event log 414 includes event messages for a designated inventory item 424 that are members of the event family 416 for the inventory item 424. In some implementations, inventory items such as inventory item 426 can be associated with an item identifier (e.g., item ID, TCIN, product number, etc.) that is used to identify the particular item within a supply chain. For each inventory item of the one or more inventory items 402, the inventory item can be associated with an event family of the one or more event families 418 based on the item identifier for the inventory item. For example, the item identifier for inventory item 426 can be used to associate the event family 416 for the inventory item 426 with one or more of but not limited to an event message, an update identifier, or other information. In some implementations, inventory for an identified inventory item can be distributed to one or more locations within a supply chain. In one example, various locations within the supply chain can store amounts of an inventory item and the state of those inventory items can be tracked at those locations and/or as they move through the supply chain using one or more inventory item updates (e.g., event messages, event message updates, events) that can include an item identifier, a location identifier, or other information.

In an example implementation of an event stream within an event streaming platform, data can be read and/or written using event messages. For example, in an event stream one or more client applications (e.g., producers, producer clients, etc.) can publish (e.g. write, send, etc.) one or more event messages. Also, for example, in an event stream, one or more client applications (e.g., consumers, consumer applications, consumer clients, subscribers, subscriber clients, etc.) can subscribe for one or more event messages such that they can read and/or process the one or more event messages received from one or more publishing client applications. An event streaming platform can be distributed and/or highly scalable. In some implementations, an event streaming platform can be implemented using one or more of but not limited to hardware, virtual machines, containers, clusters, servers, and/or other computing systems. In some implementations, an event streaming platform can use one or more of on-premises computing resources, cloud computing resources, or other computing systems. In some implementations, event logs (e.g., topics, etc.) can be partitioned (e.g., 24 partitions, or other number of partitions). Having partitions can allow a database (e.g., ROCKSDB, etc.) to persist data in RAM or other fast memory which can increase processing speed over slower live on disk persistence. In some implementations, event messages can be allocated to a partition based on an identifier (e.g., TCIN, item ID, etc.) for an inventory item. For example, a hash algorithm can be used on an item identifier number (e.g., item ID) for an inventory item to determine which partition of an event log the event message for the inventory item will be persisted on.

In some implementations, after the one or more event messages 404 are received at the application 400, one or more update identifiers, such as update identifiers 408A-N, associated with respective event messages of the one or more event messages 404 can be stored in a queue 440. For example, for each of the one or more event messages 404 received, in response to the application 400 receiving an event message and as included in the ingestion processing for the event message, the application 400 can generate an update identifier that is associated with the event message using an item identifier included in the event message and the associated update identifier can be stored on the queue 440. Each of the one or more update identifiers 408A-N can be passed to be stored on the queue 440 in the order that their respective associated event message was received at the application 400. By storing the update identifiers 408A-N based on when their respective associated event matters were received by the application 400, the ordering of the update identifiers 408A-N included in the queue 400 can be maintained based on the time of receipt of the one or more event messages 404 at the application 400. In some implementations, event messages are received at the application 400 in an order they were created based on time. Using the order that the one or more events messages are received at the application 400, the queue 440 can maintain an order of the one or more update identifiers 408A-N included in the queue 440 such that the most recently received update event message for an inventory item can be identified as a current (e.g., recently received at the application) update base on determining that an evaluated update identifier is the last update identifier member of the event family from the queue if other members of the event family are removed from the queue prior to the evaluation of the evaluated update identifier. In some implementations, the order of the one or more updated identifiers in the queue 440, such as updated identifiers 408A-N, can be based on the time the event messages are provided to the application 400 based on timestamps associated with the received event messages. In some implementations, earlier generated event messages in an event family can be associated with update identifiers organized earlier in the queue 440 than members of their event family that are generated later.

In some example implementations, an event message such as event message 442 can include one or more of key data 444 (e.g., a key, key information, a key value, etc.), value data 450 (e.g., value information, a value, value data, etc.), a timestamp 454 (e.g., time data, etc.), or other data. For example, the value data for an event message can include information for a set of one or more attributes that provide information related to an inventory item. The key data 444 of the event message 442 can include an item identifier 446 for the associated inventory item 426 that the event message 442 was generated for based on a state change of the associated inventory item 426. The key data 444 of the event message 442 can include location information for the associated inventory item such as location identifier 448 (e.g., location ID). The location identifier 448 for the event message 442, for example, can include information indicating where (e.g., at which facility, warehouse, building, distribution center store, etc.) the associated inventory item is located within the supply chain. In some example implementations, the value data 450 can include one or more fields 452 of data associated with the inventory item 426. The one or more fields 452 can include information about attributes of the state of the associated inventory item within the supply chain. For example, the data fields 452 can include information indicating the location of the inventory item (e.g., a location ID), an item identifier, or other information about the state of the inventory item. In some implementations, the data included in the event message 442 can be used to determine a state of the inventory item 426 in the supply chain. In some implementations, the one or more event logs can log changes and/or updates to one or more inventory items as they move through a supply chain using event messages. For example, when an update to the state of the inventory item 426 was made, the event message 442 was generated and added to the event log 412 to record the update and/or change to the inventory item 426 within the supply chain. An event log, for example, can store an event message that includes an update (e.g., updated information, changed data, etc.) with the most recent information for an item in the supply chain at the time of the update.

In some implementations, the queue 440 can include a KOTLIN channel or another queue. In some implementations, one or more update identifiers can be put on the queue and/or removed from the queue 440. For example, the queue 440 can store the update identifiers in the order they were put on the queue 440 and an update identifier at the end of the queue 440 can be removed which can maintain the ordering of the update identifiers remaining in the queue 440. In one example, update identifier 408A which is located at the end of the queue 440 can be removed from the queue for evaluation using update evaluator 480 which can be included in application 400. The update identifier 408A can include key data 432 that can include but is not limited to an item identifier 434 (e.g., item ID, TCIN, product number, SKU, etc.) for the associated inventory item 426, a location identifier 435 (e.g., location ID, location information, etc.) for the associated inventory item, or other key data. The item identifier 434 that is included in the update identifier 408A can correspond with the update identifier 446 included in the event message 442 as the update identifier 446 and the event message 442 are associated with the same event family for the inventory item 426. In some example implementations, the update identifier can include information about an update type 436. The update type 436 can include but is not limited to an update, a delete, or another update type. In some example implementations, an update type that includes an update can indicate that the update identifier was generated from an event message that was generated based on an update to an inventory item that is relevant for processing. In another example implementation, an update type that includes a delete can indicate that the update identifier was generated from an event message that can be removed from a database. For example, when an event message is received by the application 400 that includes value data that includes a null payload (e.g., empty payload, null data, etc.), an update identifier that includes a delete update type can be generated for the event message and placed on the queue 440. Responsive to evaluating the update identifier that includes a delete update type at the application 400, the associated event message persisted in the database 422 can be determined not to be relevant for processing and can be deleted from the database 422.

In some implementations, after the one or more event messages are received, the application 400 can update one or more counters 430 that indicate how many update identifiers are included in the queue 440 for each event family associated with the respective update identifiers included in the queue 440. For example, as part of ingestion processing for the received event message 442, application 400 can increment a counter 438 for the event family associated with inventory item 426 in response to member event message 442 being received at the application 400 to add the count of update identifier members in the event family associated with inventory item 426 that are included in the queue 440 when an associated update identifier 408A is stored on the queue 440. Each of the one or more counters 430 can be associated with an identified event family based on an item identifier used to track the event family. Each of the one or more counters 430 can keep a count of the amount of update identifiers included in the queue 440 for each of the event families associated with the one or more update identifiers that are included in the queue 440.

In some implementations, the one or more counters 430 can indicate the amount of update identifiers that are included in the queue 440 for each event family represented by (e.g., associated with) the one or more update identifiers included in the queue 440. For example, counter 438 can indicate the amount of update identifiers that are included in the queue 440 for the event family 416 associated with item identifier 446 for inventory item 426. In one example, the event family members can be identified or determined as included in an event family based on an item identifier included in the update identifiers that include corresponding item identifiers associated with the event family. There can be, for example, a counter for each event family represented by associated update identifiers included in the queue 440.

In some implementations, after the one or more event messages are received, the application 400 can store the one or more event messages 404 in a database 422. For example, as an event message is received, such as event message 442, as included in the ingestion processing for the event message, it can be stored in the database 422, as shown at 458, associated with an inventory item as the most recent received update for the inventory item and/or event family. In another example implementation, as an event message is received, as part of ingestion processing for the event message, it can be stored in the database 422 associated with an inventory item and one or more other attributes (e.g., location ID, quantity, etc.) included in the event message as the most recent received update for the inventory item and/or event family based on at least one of the one or more attributes. For example, an event message for an update to an inventory item located at a particular location designated by a location identifier (e.g., location ID) included in the event message can be stored in the database 422 as the most current update for the identified inventory item at the identified location based on the item identifier information and the location information (e.g., a location ID) included in the event message. In some implementations, one or more event messages for an event family can be persisted in the database 422 as current updates for inventory items at designated locations. For example, one or more event messages 428 can be stored in the database 422 that include an item identifier such as item identifier 446 associating them with the event family 416 and the one or more event messages 428 can be associated with inventory items at locations identified by location identifiers included in the respective one or more event messages 428. In some implementations, the most currently received event messages that are members of an event family for various locations can be stored in the database 422. In some implementations, a currently received event message that is associated with an identified event family based on an item identifier and/or a location identifier can replace, within the database, an earlier received (e.g., outdated) event message that is associated with the identified event family. In another example, a received event message can be stored in the database such that it is inserted as associated with an event family and/or inventory item based on an item identifier and/or a location identifier. For example, if the database 422 does not have an event message entry associated with an identified event family and/or inventory item based on an item identifier and/or a location identifier for the inventory item that is included in the event message, then the event message can be inserted into the database 422 as a first entry associated with the item identifier. In some implementations, the state of an inventory item can be determined by the most recent updated event message information for that inventory item. For example, as event messages are received over time indicating various updates to information and/or the state for an associated inventory item, the most recently received event message can be stored in the database to reflect the most recent updates and/or state of the inventory item in the supply chain. By storing the most recent update for the inventory item in the database 422, applications can have access to the most updated information for an inventory item as it is tracked through the supply chain. In some implementations, the database 422 can include a persistent key-value store (e.g., ROCKSDB, etc.) or other database type. For example, the database 422 can be organized to store and/or retrieve key-value data efficiently (e.g., fast, quickly, etc.) and/or can be persisted in memory (e.g., RAM, etc.) or using a storage device. In some implementations, the described one or more event logs and/or databases can be implemented to operate in one or more memories which can be beneficial in allowing scalability of processing and reducing processing times when processing high levels of updates to inventory items within a supply chain. Additionally, in FIG. 4, one or more communications networks such as the network 490 can be used to communicate information between systems including but not limited to the one or more event logs 410, the application 400, the database 422, and/or other described systems.

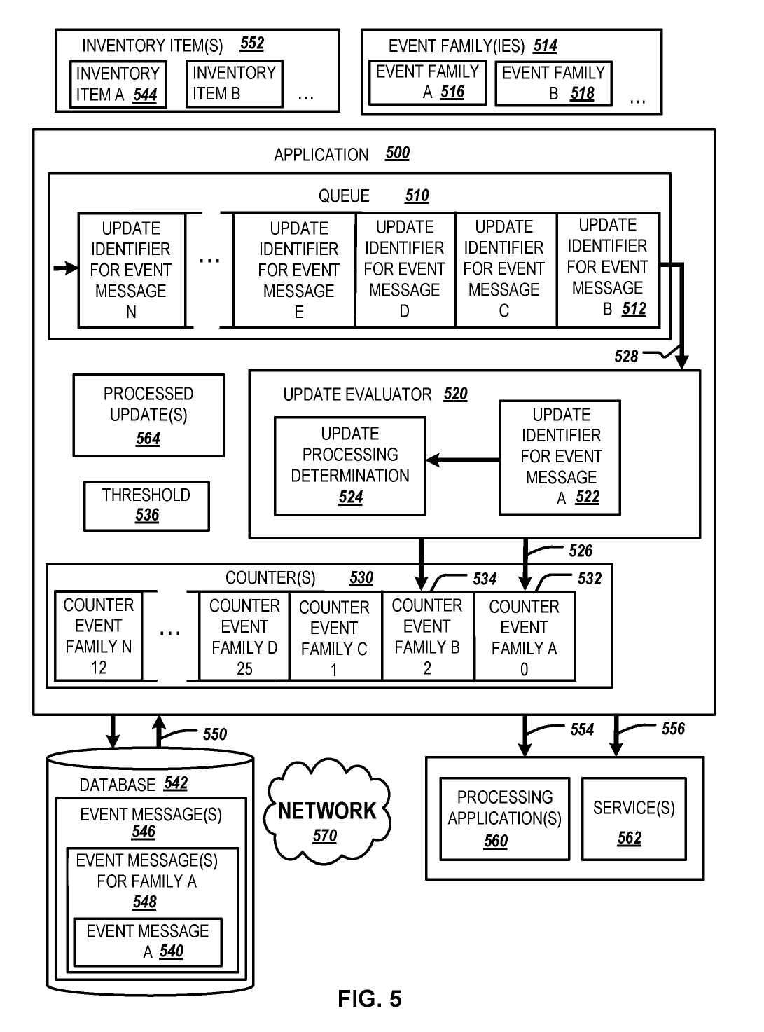

FIG. 5. is a diagram that shows an example application 500 that can evaluate one or more update identifiers for processing updates for inventory items in a supply chain. The functionality of application 500 can be included in applications described and depicted herein such as applications described in system 100 of FIG. 1 or application 400 described in FIG. 4. In the example of FIG. 5, the application 500 includes an update evaluator 520 (e.g., update evaluation logic, etc.) which can be used to determine if an update identifier is the last update identifier included in a queue 510 for its corresponding event family of one or more event families 514 based on a counter of the one or more counters 530. For example, update evaluator 520 can determine if the update identifier 522 is the last update identifier member of its associated event family 516 that is from the queue 510 based on the corresponding event family counter 532 for the event family 516 of the update identifier 522. As shown at 528, the update identifier 522 is received at the update evaluator 520 from the queue 510. In some implementations, an update identifier at the end of the queue 510 can be evaluated and if a counter for a designated event family indicates that there are no other update identifiers for the designated event family included in the queue 510, the update identifier can be determined to be the last update identifier member from the queue 510.

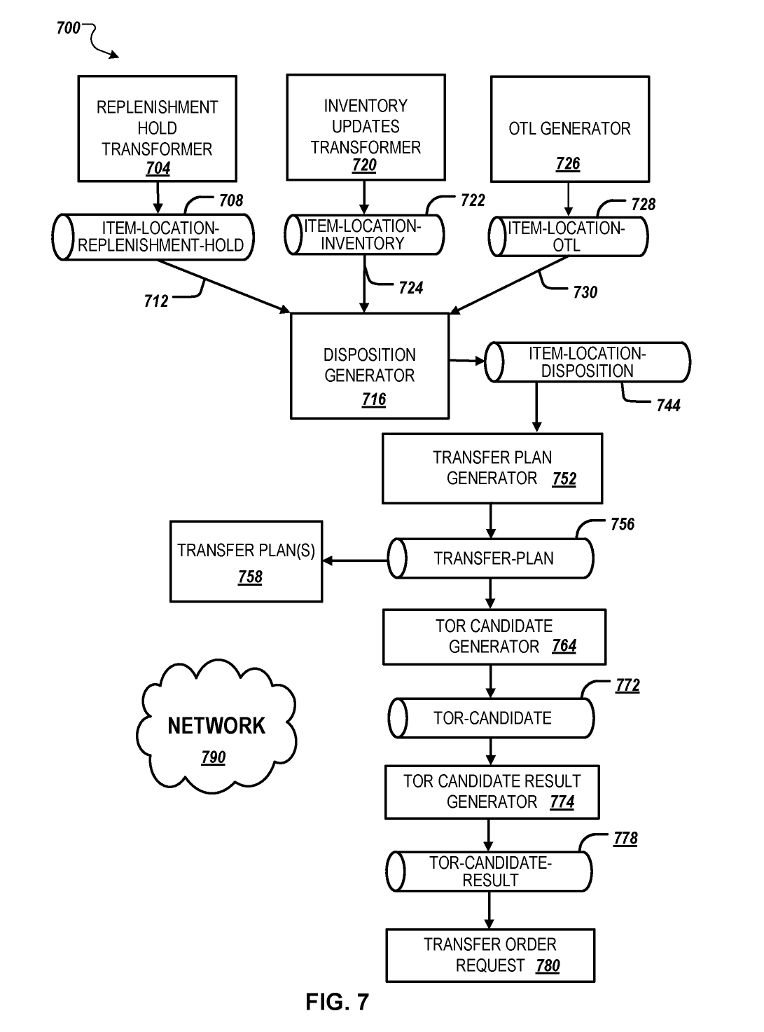

In the shown example, the value of counter 532 as evaluated indicates that update identifier 522 is the last update identifier member from the queue 510 for the associated event family 516 as there are no other event family members left in the queue 510. In some example implementations, the update evaluator 520 can compare the value of the counter 532 to one or more thresholds such as threshold 536 to determine that the update identifier 522 is the last member of its event family 516 from the queue 510. In the example of FIG. 5, the value of the counter 532 is indicated as zero which indicates that there are no other event family members left in the queue 510 as there are no more update identifiers included in the queue 510 based on the value of counter 532 compared to a threshold set at zero. Based on the value of counter 532, the update evaluator 520 can generate and/or return an update processing determination 524 indicating that update identifier 522 is the last update identifier from the queue for its associated event family 516. In another implementation, based on the value of counter 532 when evaluated, the update evaluator 520 can generate and/or return an update processing determination 524 indicating that there are no other update identifier members for the event family 516 associated with update identifier 522 included in the queue 510. The update evaluator 520 can indicate if the update identifier 522 is the last member of its event family from the queue 510 or if there are more update identifier members of the event family counted as included in the queue 510 that are available for evaluation. The event message 540 can be stored in database 542, and the update identifier 522 can be associated with the stored event message 540 which can include current update information for inventory item 544. Based on the update processing determination 524 indicating that update identifier 522 is the last update identifier from the queue for its associated event family 516, event message 540 can be processed as it can be determined to be a current update for the event family 516 that is included in the database 542. In another example, one or more event messages 548 that are members of the event family 516 that are stored in database 542 can be processed based on the update processing determination 524 indicating that update identifier 522 is the last update identifier from the queue for event family 516. Any of the one or more event messages 564 including the event message 540 can be received from the database 150 for processing at the application 500 as shown at 550. In some implementations, an event message can be processed using application 500 to generate one or more processed updates 564. In some implementations, communicated data (e.g., an event message, an update identifier, etc.) can be communicated using one or more communications networks such as network 570. The stored event message 540 can be retrieved from the database 542 for processing at application 500 to generate one or more processed updates 564. In another implementation, as shown at 554, event message 540 can be provided by application 500 for downstream processing by one or more processing applications 560 and/or one or more services 562. In another implementation, as shown at 556, the one or more processed updates can be provided downstream by application 500 to one or more processing applications 560 and/or one or more services 562. For example, the one or more processing applications 560 and/or one or more services 562 can include one or more processing applications and/or one or more services as described herein including but not limited to the transfer order candidate result generator 764 in FIG. 7, the transfer order request candidate result generator 774 in FIG. 7, or another processing application and/or service.

In some implementations, the processing of the one or more event messages 548 can include generating a transfer plan. For example, the application 500 can process the one or more event messages 548 to make an inventory allocation decision including generating one or more transfer plans. In some implementations, a transfer plan can be included in the one or more processed updates 564. For example, the application 500 can be included in a transfer plan generator such as transfer plan generator 752 of FIG. 7, and the application 500 can generate a processed update that includes a transfer plan. The transfer plan can determine (e.g., indicate, specify, etc.) where (e.g., to which warehouse, store, building, facility, etc.) at least some of the one or more inventory items 552 are to be relocated within the supply chain. The application 500 can make an inventory allocation decision and/or transfer plan allocating one or more of the inventory items 552 by processing at least one of the one or more event messages 546. In one example implementation, the one or more event messages 546 associated with event family 516 can be for inventory items located at different locations and waiting until it is determined that the current updates for the inventory items of the event family are persisted in database 542 before processing the one or more event messages 546 can provide more efficient processing. Avoiding processing of each intermediate update to inventory items as they move through a supply chain can avoid expensive processing such as processing for allocation decisions and transfer plan processing, and/or other expensive processing.

In some implementations, when the update evaluator 520 receives an update identifier from the queue 510, the update identifier can be removed from the queue. For example, update identifier 522 is shown as having been removed from the queue 510 and the next available update identifier for evaluation from the queue 510 is the update identifier 512. The update identifier 512 is associated with a different event family 518 than update identifier 522 and can have a corresponding counter 534 that indicates that update identifier 512 is not the last member of its event family 518 from the queue 510. Based on the value of the counter 534 being above a threshold number (e.g., 0, or other threshold), the update evaluator can use that value to determine that the update identifier 512 is not the last member of its event family 518 from the queue 510 and identify that there are more recent update identifiers included in the queue 510 for the corresponding event family 518 and/or inventory item and that the update identifier 512 corresponds to an event message for an intermediate update that can be ignored and/or not provided for processing. For example, based on the determination that the update identifier 512 is not the last member of its event family 518 from the queue, one or more event messages associated with the event family 518 can be avoided for processing and/or not processed. In some implementations, when an update identifier is removed from the queue 510, the update evaluator 520 can decrement the counter for the corresponding event family to maintain an accurate count of the update identifiers remaining in the queue 510 for the event family after the update identifier is removed. For example, responsive to receiving the update identifier 522, as shown at 526, the update evaluator 520 can decrement the counter 532 for the corresponding event family 516. As the update evaluator 520 iterates through update identifiers provided from the queue 500, the update evaluator 520 can decrement respective counters of the one or more counters 530 to update the counts of the update identifiers for each of the event families included in the queue 510. By maintaining a count of update identifiers for an associated event family for an inventory item in the queue 510, the application 500 can look back into the queue 510 to determine if there are more recent updates for the inventory item to be processed.

In some implementations, the update evaluator 520 can iterate through update identifiers as they are received from the end of the queue 510. For example, after an update identifier is evaluated and the update evaluator 520 determines if it is the last member of its event family from the queue 510, the update evaluator 520 can receive the next update identifier off the queue 510. The update evaluator 520 can iterate through the update identifiers in the order they are organized in the queue 510 to allow for the efficient processing of the one or more event messages 546 stored in database 542 that include current updates for one or more inventory items 552.

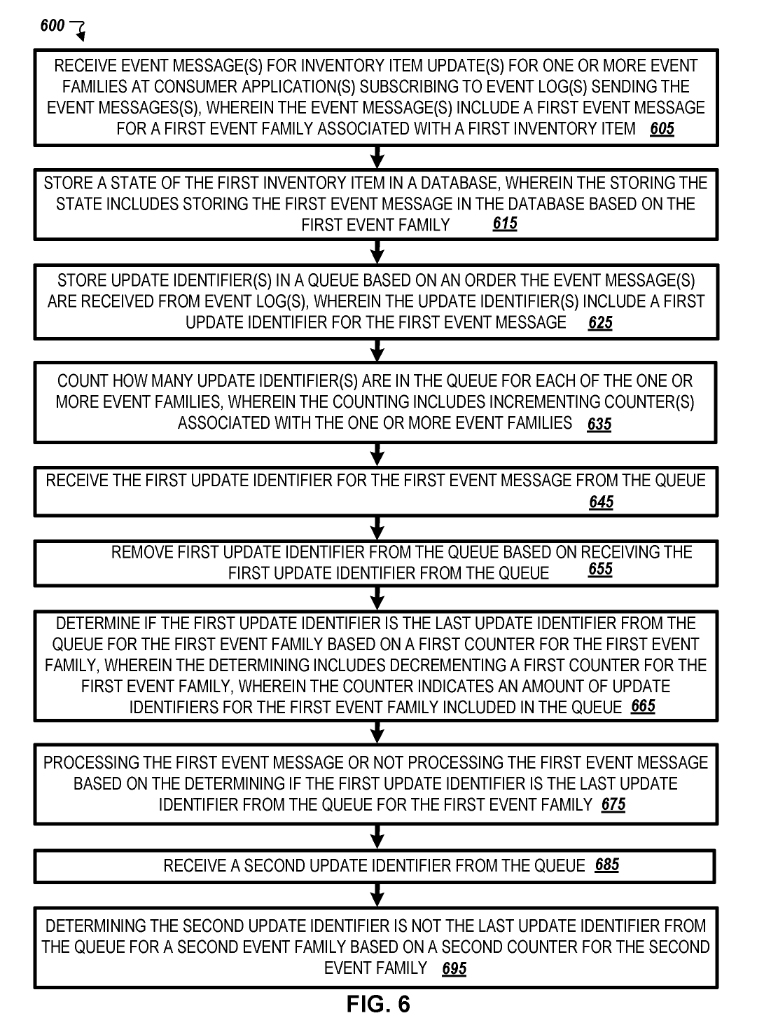

FIG. 6 shows a diagram of an example process 600 for processing an event message update for an inventory item in a supply chain. The process 600 can be performed using one or more computing systems, as described and depicted herein. For example, the process 600 can be performed by the computing system 800 in FIG. 8. In the example implementation of FIG. 6, at step 605, one or more event messages for one or more updates for one or more inventory items for one or more event families can be received at one or more consumer applications subscribing to one or more event logs sending the one or more event messages. The one or more event messages can include a first event message for a first event family associated with a first inventory item. In some implementations, an event message can be associated with an event family based on the item identifier. For example, an event massage can include an item identifier in its data and that event message can be included in the event family of event messages for that item identifier. At 615, a state of the first inventory item is stored in a database based on the first event family. The storing the state of the first inventory item can include storing the first event message in the database based on the first event family for the first inventory item. At 625, one or more update identifiers are stored in a queue based on an order the one or more event messages are received from the one or more event logs. The one or more update identifiers can include a first update identifier for (e.g., associated with) the first event message. The first update identifier and the first event message can be associated based on an item identifier for the first inventory item. At 635, an amount of the one or more update identifiers that are included in the queue for each of the one or more event families are counted. The counting can include incrementing one or more counters associated with the one or more event families. The one or more event families can be associated with the one or more update identifiers stored in the queue based on respective item identifiers included in the update identifiers. At 645, the first update identifier for the first event message can be received from the queue. For example, the first update identifier, that is associated with the first event message based on included item identifier information, can be at the end of the queue and can be received by an update evaluator for evaluation. At 655, the first update identifier can be removed from the queue based on the receiving (e.g., at an update evaluator) the first update identifier provided from the queue. For example, responsive to the first update identifier being received at an update evaluator for evaluation, the update identifier can be removed from the queue. At 665, it is determined if the first update identifier is the last update identifier from the queue for the first event family based on a first counter for the first event family. The determination can include decrementing a first counter for the first event family. The first counter can indicate the amount of update identifiers that are included in the queue that are associated with (e.g., members of) the first event family. For example, an update evaluator can decrement the value of the first counter based on receiving the first update identifier and based on the decremented value, the update evaluator can determine if the update identifier is the last update identifier from the queue for the first event family. At 675, the first event message is processed or not processed based on the determination of if the first update identifier is the last update identifier from the queue for the first event family. At 685, a second update identifier can be received from the queue. For example, a second update identifier associated with a second event family can be received from the end of the ordered queue at an update evaluator. At 695, a determination is made that the second update identifier is not the last update identifier from the queue for a second event family based on a second counter for the second event family.

FIG. 7 shows a diagram of an example architecture 700 for an inventory replenishment system in which processing of updates to inventory items can be used. In some implementations, the example architecture 700 can be included in an implementation of an inventory replenishment system such as inventory replenishment system 260. An implementation of the architecture 700 can include the use of one or more computing systems as described and depicted herein. For example, the architecture 700 can be implemented including the use of the computing system 800 in FIG. 8. In some implementations, the architecture 700 can include a distributed event store and stream-processing platform (e.g. APACHE KAFKA, etc.) distributed over one or more networks such as network 790 and/or one or more databases (e.g. ROCKSDB, etc.). In some implementations, the architecture 700 can include the use of event streaming to store and process events generated by changes in a supply chain to update and maintain the state of the supply chain. In some implementations, the architecture 700 can include one or more topics distributed over one or more clusters. In some examples, the one or more topics can be partitioned into one or more partitions. In the example of FIG. 7, one or more event messages for inventory item updates can be received and/or processed at 720, and that information can be stored and accessible through topic signals as shown at 722. At 724, inventory information for items at their locations can be accessible to a disposition generator 716. Additionally, updates to aspects of inventory items can be processed and/or received at 704, and that information can be stored and accessible through topic signals as shown at 708. At 712, inventory information regarding holds for inventory items at locations can be accessible to a disposition generator 716. At 726 the desired inventory levels for items in the supply chain can be determined at their respective locations and that information for each item at the item identification level can be stored and accessible through topic signals as shown at 728. At 730, information about desired levels of inventory for items at their locations can be accessible to a disposition generator 716. The disposition generator 516 can determine disposition information for items in the supply chain at their respective locations and that information can be stored and accessible through topic signals (e.g., events, event records, messages, etc.) as shown at 744. Information for determining one or more transfer plans for inventory items in a supply chain can be generated at the transfer plan generator 752 and information for one or more generated transfer plans 758 for inventory items can be stored and accessible through topic signals as shown at 756. The transfer plan generator 752 can include one or more applications and/or databases as described herein such as application 120 of FIG. 1, application 400 of FIG. 4, and/or application 500 of FIG. 5. In the example implementation of FIG. 7, transfer order candidate information can be generated at a transfer order candidate result generator 764 and information for transfer order candidates for inventory items in the supply chain can be stored and accessible through topic signals as shown at 772. Further, transfer order request information can be generated at a transfer order request candidate result generator 774 and information for transfer order requests for items in the supply chain can be stored and accessible through topic signals as shown at 778. Also, one or more generated transfer order requests 780 can be stored and accessible for one or more items in the supply chain.

FIG. 8 is a schematic diagram that shows an example of a computing system 800 that can be used to implement the techniques described herein. The computing system 800 includes one or more computing devices (e.g., computing device 810), which can be in wired and/or wireless communication with various peripheral device(s) 880, data source(s) 890, and/or other computing devices (e.g., over network(s) 870). The computing device 810 can represent various forms of stationary computers 812 (e.g., workstations, kiosks, servers, mainframes, edge computing devices, quantum computers, etc.) and mobile computers 814 (e.g., laptops, tablets, mobile phones, personal digital assistants, wearable devices, etc.). In some implementations, the computing device 810 can be included in (and/or in communication with) various other sorts of devices, such as data collection devices (e.g., devices that are configured to collect data from a physical environment, such as microphones, cameras, scanners, sensors, etc.), robotic devices (e.g., devices that are configured to physically interact with objects in a physical environment, such as manufacturing devices, maintenance devices, object handling devices, etc.), vehicles (e.g., devices that are configured to move throughout a physical environment, such as automated guided vehicles, manually operated vehicles, etc.), or other such devices. Each of the devices (e.g., stationary computers, mobile computers, and/or other devices) can include components of the computing device 810, and an entire system can be made up of multiple devices communicating with each other. For example, the computing device 810 can be part of a computing system that includes a network of computing devices, such as a cloud-based computing system, a computing system in an internal network, or a computing system in another sort of shared network. Processors of the computing device (810) and other computing devices of a computing system can be optimized for different types of operations, secure computing tasks, etc. The components shown herein, and their functions, are meant to be examples, and are not meant to limit implementations of the technology described and/or claimed in this document.

The computing device 810 includes processor(s) 820, memory device(s) 830, storage device(s) 840, and interface(s) 850. Each of the processor(s) 820, the memory device(s) 830, the storage device(s) 840, and the interface(s) 850 are interconnected using a system bus 860. The processor(s) 820 are capable of processing instructions for execution within the computing device 810 and can include one or more single-threaded and/or multi-threaded processors. The processor(s) 820 are capable of processing instructions stored in the memory device(s) 830 and/or on the storage device(s) 840. The memory device(s) 830 can store data within the computing device 810, and can include one or more computer-readable media, volatile memory units, and/or non-volatile memory units. The storage device(s) 840 can provide mass storage for the computing device 810, can include various computer-readable media (e.g., a floppy disk device, a hard disk device, a tape device, an optical disk device, a flash memory or other similar solid state memory device, or an array of devices, including devices in a storage area network or other configurations), and can provide date security/encryption capabilities.

The interface(s) 850 can include various communications interfaces (e.g., USB, Near-Field Communication (NFC), Bluetooth, WiFi, Ethernet, wireless Ethernet, etc.) that can be coupled to the network(s) 870, peripheral device(s) 880, and/or data source(s) 890 (e.g., through a communications port, a network adapter, etc.). Communication can be provided under various modes or protocols for wired and/or wireless communication. Such communication can occur, for example, through a transceiver using a radio-frequency. As another example, communication can occur using light (e.g., laser, infrared, etc.) to transmit data. As another example, short-range communication can occur, such as using Bluetooth, WiFi, or other such transceiver. In addition, a GPS (Global Positioning System) receiver module can provide location-related wireless data, which can be used as appropriate by device applications. The interface(s) 850 can include a control interface that receives commands from an input device (e.g., operated by a user) and converts the commands for submission to the processors 820. The interface(s) 850 can include a display interface that includes circuitry for driving a display to present visual information to a user. The interface(s) 850 can include an audio codec which can receive sound signals (e.g., spoken information from a user) and convert it to usable digital data. The audio codec can likewise generate audible sound, such as through an audio speaker. Such sound can include real-time voice communications, recorded sound (e.g., voice messages, music files, etc.), and/or sound generated by device applications.

The network(s) 870 can include one or more wired and/or wireless communications networks, including various public and/or private networks. Examples of communication networks include a LAN (local area network), a WAN (wide area network), and/or the Internet. The communication networks can include a group of nodes (e.g., computing devices) that are configured to exchange data (e.g., analog messages, digital messages, etc.), through telecommunications links. The telecommunications links can use various techniques (e.g., circuit switching, message switching, packet switching, etc.) to send the data and other signals from an originating node to a destination node. In some implementations, the computing device 810 can communicate with the peripheral device(s) 880, the data source(s) 890, and/or other computing devices over the network(s) 870. In some implementations, the computing device 810 can directly communicate with the peripheral device(s) 880, the data source(s), and/or other computing devices.

The peripheral device(s) 880 can provide input/output operations for the computing device 810. Input devices (e.g., keyboards, pointing devices, touchscreens, microphones, cameras, scanners, sensors, etc.) can provide input to the computing device 810 (e.g., user input and/or other input from a physical environment). Output devices (e.g., display units such as display screens or projection devices for displaying graphical user interfaces (GUIs)), audio speakers for generating sound, tactile feedback devices, printers, motors, hardware control devices, etc.) can provide output from the computing device 810 (e.g., user-directed output and/or other output that results in actions being performed in a physical environment). Other kinds of devices can be used to provide for interactions between users and devices. For example, input from a user can be received in any form, including visual, auditory, or tactile input, and feedback provided to the user can be any form of sensory feedback (e.g., visual feedback, auditory feedback, or tactile feedback).

The data source(s) 890 can provide data for use by the computing device 810, and/or can maintain data that has been generated by the computing device 810 and/or other devices (e.g., data collected from sensor devices, data aggregated from various different data repositories, etc.). In some implementations, one or more data sources can be hosted by the computing device 810 (e.g., using the storage device(s) 840). In some implementations, one or more data sources can be hosted by a different computing device. Data can be provided by the data source(s) 890 in response to a request for data from the computing device 810 and/or can be provided without such a request. For example, a pull technology can be used in which the provision of data is driven by device requests, and/or a push technology can be used in which the provision of data occurs as the data becomes available (e.g., real-time data streaming and/or notifications). Various sorts of data sources can be used to implement the techniques described herein, alone or in combination.

In some implementations, a data source can include one or more data store(s) 890a (e.g., databases, or other sorts of data management systems). The data store(s) can be provided by a single computing device or network (e.g., on a file system of a server device) or provided by multiple distributed computing devices or networks (e.g., hosted by a computer cluster, hosted in cloud storage, etc.). In some implementations, a database management system (DBMS) can be included to provide access to data contained in database(s) (e.g., through the use of a query language and/or application programming interfaces (APIs)). The database(s), for example, can include relational databases, object databases, structured document databases, unstructured document databases, graph databases, and other appropriate types of databases.

In some implementations, a data source can include one or more blockchains 890b. A blockchain can be a distributed ledger that includes blocks of records that are securely linked by cryptographic hashes. Each block of records includes a cryptographic hash of the previous block, and transaction data for transactions that occurred during a time period. The blockchain can be hosted by a peer-to-peer computer network that includes a group of nodes (e.g., computing devices) that collectively implement a consensus algorithm protocol to validate new transaction blocks and to add the validated transaction blocks to the blockchain. By storing data across the peer-to-peer computer network, for example, the blockchain can maintain data quality (e.g., through data replication) and can improve data trust (e.g., by reducing or eliminating central data control).

In some implementations, a data source can include one or more machine learning systems 890c. The machine learning system(s) 890c, for example, can be used to analyze data from various sources (e.g., data provided by the computing device 810, data from the data store(s) 890a, data from the blockchain(s) 890b, and/or data from other data sources), to identify patterns in the data, and to draw inferences from the data patterns. In general, training data 892 can be provided to one or more machine learning algorithms 894, and the machine learning algorithm(s) can generate a machine learning model 896. Execution of the machine learning algorithm(s) can be performed by the computing device 810, or another appropriate device. Various machine learning approaches can be used to generate machine learning models, such as supervised learning (e.g., in which a model is generated from training data that includes both the inputs and the desired outputs), unsupervised learning (e.g., in which a model is generated from training data that includes only the inputs), reinforcement learning (e.g., in which the machine learning algorithm(s) interact with a dynamic environment and are provided with feedback during a training process), or another appropriate approach. A variety of different types of machine learning techniques can be employed, including but not limited to convolutional neural networks (CNNs), deep neural networks (DNNs), recurrent neural networks (RNNs), and other types of multi-layer neural networks. With respect to the technology described herein, the training data can include data that represents supply chain information for inventory items and/or event messages. The machine learning model that results from the machine learning algorithm(s) can be used to efficiently process event messages for inventory item updates in a supply chain. Use of the machine learning model can provide the benefit of efficiencies in processing updates for inventory items based on evaluating the timeliness of event messages.

Various implementations of the systems and techniques described herein can be realized in digital electronic circuitry, integrated circuitry, specially designed ASICs (application specific integrated circuits), computer hardware, firmware, software, and/or combinations thereof. A computer program product can be tangibly embodied in an information carrier (e.g., in a machine-readable storage device), for execution by a programmable processor. Various computer operations (e.g., methods described in this document) can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, by a computer to perform a certain activity or bring about a certain result. A computer program can be written in any form of programming language, including compiled or interpreted languages, and can be deployed in any form, including as a stand-alone program or as a module, component, subroutine, or other unit suitable for use in a computing environment. A computer program product can be a computer- or machine-readable medium, such as a storage device or memory device. As used herein, the terms machine-readable medium and computer-readable medium refer to any computer program product, apparatus and/or device (e.g., magnetic discs, optical disks, memory, etc.) used to provide machine instructions and/or data to a programmable processor, including a machine-readable medium that receives machine instructions as a machine-readable signal. The term machine-readable signal refers to any signal used to provide machine instructions and/or data to a programmable processor.

Suitable processors for the execution of a program of instructions include, by way of example, both general and special purpose microprocessors, and can be a single processor or one of multiple processors of any kind of computer. Generally, a processor will receive instructions and data from a read-only memory or a random access memory or both. The elements of a computer are a processor for executing instructions and one or more memory devices for storing instructions and data. Generally, a computer can also include, or can be operatively coupled to communicate with, one or more mass storage devices for storing data files. Such devices can include magnetic disks (e.g., internal hard disks and/or removable disks), magneto-optical disks, and optical disks. Storage devices suitable for tangibly embodying computer program instructions and data can include all forms of non-volatile memory, including by way of example semiconductor memory devices, flash memory devices, magnetic disks (e.g., internal hard disks and removable disks), magneto-optical disks, and optical disks. The processor and the memory can be supplemented by, or incorporated in, ASICs (application-specific integrated circuits).

The systems and techniques described herein can be implemented in a computing system that includes a back end component (e.g., a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). The computer system can include clients and servers, which can be generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A computer system for processing inventory item updates, the system comprising:
one or more processors; and
computer-readable memory storing instructions that, when executed by the processors, cause the processors to perform operations comprising:
receiving one or more event messages for one or more inventory item updates for one or more event families;
storing one or more update identifiers for the one or more event messages in a queue, wherein the one or more update identifiers comprise a first update identifier for a first event message for a first event family;
counting how many of the one or more update identifiers are included in the queue for each of the one or more event families;
receiving the first update identifier from the queue;
determining if the first update identifier for the first event message is the last update identifier from the queue for the first event family based on a first counter for the first event family;
based on the determining if the first update identifier is the last update identifier from the queue for the first event family, processing the first event message or not processing the first event message.

2. The computer system of claim 1, wherein the operations further comprise:
receiving a second update identifier for a second event message from the queue; and
determining that the second update identifier is not the last update identifier from the queue for a second event family based on a second counter for the second event family.

3. The computer system of claim 1, wherein the operations further comprise:
storing, in a database, an update to the state of a first inventory item associated with the first event family, wherein the storing the update to the state comprises storing the first event message in the database based on the first event family.

4. The computer system of claim 1, wherein the counting how many of the one or more update identifiers are included in the queue for each of the one or more event families comprises incrementing one or more counters associated with the one or more event families based on the received one or more event messages; and
wherein the determining if the first update identifier is the last update identifier from the queue for the first event family comprises decrementing a first counter for the first event family, wherein the first counter counts an amount of the one or more update identifiers that are included in the queue for the first event family.

5. The computer system of claim 1, wherein the operations further comprise removing the first update identifier from the queue based on the receiving the first update identifier from the queue.

6. The computer system of claim 1, wherein the one or more update identifiers are stored in the queue based on an order the one or more event messages are received from one or more event logs.

7. The computer system of claim 1, wherein the first event message is processed if the first update identifier is determined to be the last update identifier from the queue for the first event family based on the first counter for the first event family.

8. The computer system of claim 1, wherein the processing comprises generating a transfer plan.

9. The computer system of claim 6, wherein the event logs comprise one or more topics; and
wherein the one or more event messages for the one or more event families are received at one or more consumer applications that subscribe to the one or more topics.

10. The computer system of claim 1, wherein the queue comprises a Kotlin channel.

11. A method for processing inventory item updates, the method comprising:
receiving one or more event messages for one or more inventory item updates for one or more event families;
storing one or more update identifiers for the one or more event messages in a queue, wherein the one or more update identifiers comprise a first update identifier for a first event message for a first event family;
counting how many of the one or more update identifiers are included in the queue for each of the one or more event families;
receiving the first update identifier from the queue;
determining if the first update identifier for the first event message is the last update identifier from the queue for the first event family based on a first counter for the first event family;
based on the determining if the first update identifier is the last update identifier from the queue for the first event family, processing the first event message or not processing the first event message.

12. The method of claim 11, the method further comprises:
receiving a second update identifier for a second event message from the queue; and
determining that the second update identifier is not the last update identifier from the queue for a second event family based on a second counter for the second event family.

13. The method of claim 11, wherein the method further comprises:
storing, in a database, an update to the state of a first inventory item associated with the first event family, wherein the storing the update to the state comprises storing the first event message in the database based on the first event family.

14. The method of claim 11, wherein the counting how many of the one or more update identifiers are included in the queue for each of the one or more event families comprises incrementing one or more counters associated with the one or more event families based on the received one or more event messages; and
wherein the determining if the first update identifier is the last update identifier from the queue for the first event family comprises decrementing a first counter for the first event family, wherein the first counter counts an amount of the one or more update identifiers that are included in the queue for the first event family.

15. The method of claim 11, the method further comprising removing the first update identifier from the queue based on the receiving the first update identifier from the queue.

16. The method of claim 11, wherein the one or more update identifiers are stored in the queue based on an order the one or more event messages are received from one or more event logs.

17. The method of claim 11, wherein the first event message is processed if the first update identifier is determined to be the last update identifier from the queue for the first event family based on the first counter for the first event family.

18. The method of claim 11, wherein the processing comprises generating a transfer plan.

19. The method of claim 16, wherein the event logs comprise one or more topics; and
wherein the one or more event messages for the one or more event families are received at one or more consumer applications that subscribe to the one or more topics.

20. A method for processing inventory item updates, the method comprising:
receiving one or more event messages for one or more inventory item updates for one or more event families at one or more consumer applications that subscribe to one or more event logs sending the one or more event messages, wherein the one or more event messages include a first event message for a first event family associated with a first inventory item;
storing one or more updates to the state of the first inventory item in a database, wherein the storing the state comprises storing the first event message in the database based on the first event family;
storing one or more update identifiers in a queue based on an order the one or more event messages are received from the one or more event logs, wherein the one or more update identifiers comprise a first update identifier for the first event message;
counting how many of the one or more update identifiers are in the queue for each of the one or more event families, wherein the counting comprises incrementing one or more counters associated with the one or more event families;
receiving the first update identifier for the first event message from the queue;
based on the receiving the first update identifier from the queue, removing the first update identifier from the queue;
determining if the first update identifier is the last update identifier from the queue for the first event family based on a first counter for the first event family, wherein the determining comprises decrementing the first counter for the first event family, wherein the first counter indicates an amount of update identifiers for the first event family included in the queue;
based on the determining if the first update identifier is the last update identifier from the queue for the first event family, processing the first event message or not processing the first event message;
receiving a second update identifier from the queue;
determining that the second update identifier is not the last update identifier from the queue for a second event family based on a second counter for the second event family.
